(19) United States
(12) Patent Application Publication
(10) Pub. No.: US 2016/0232252 A1
(43) Pub. Date: Aug. 11, 2016

(54) METHOD FOR LOADING WEBPAGE, DEVICE AND BROWSER THEREOF

(71) Applicant: BEIJING QIHOO TECHNOLOGY COMPANY LIMITED, Beijing (CN)

(72) Inventors: Long CAO, Beijing (CN); Huan REN, Beijing (CN)

(73) Assignee: Beijing Qihoo Technology Company Limited, Beijing (CN)

(21) Appl. No.: 15/025,219

(22) PCT Filed: Sep. 12, 2014
(86) PCT No.: PCT/CN2014/086428

§ 371 Date: Mar. 25, 2016

(30) Foreign Application Priority Data
Sep. 27, 2013 (CN) 201310459986.4

(51) Int. Cl. G06F 17/30; H04L 29/08

(52) U.S. Cl. CPC G06F 17/30887; G06F 17/3089; G06F 17/30864; H04L 67/02

(57) ABSTRACT

A method for loading a webpage is disclosed, comprising: receiving a first loading request of a current webpage at a browser side using a first browser kernel; the first loading request including URL of the current webpage; starting obtaining and caching a first webpage resource according to the first loading request; the first webpage resource being webpage resource needed in loading the current webpage; searching a browser kernel matching the current webpage according to the URL; starting a second browser kernel when the browser kernel matching the current webpage is the second browser kernel; loading the current webpage by the second browser kernel based on the first webpage resource and the second webpage resource transmitted by the first browser kernel; wherein the second webpage resource is remaining webpage resource needed in loading the current webpage except the first webpage resource obtained from a server side by the first browser kernel.

### CROSS-REFERENCE TO RELATED APPLICATIONS

This application is the national stage of International Application No. PCT/CN2014/086428 filed Sep. 12, 2014, which is based upon and claims priority to Chinese Patent Application No. CN201310459986.4, filed Sep. 27, 2013, the entire contents of which are incorporated herein by reference.

### FIELD OF TECHNOLOGY

The disclosure relates to the field of browser and, particularly to a method for loading a webpage, a device for loading a webpage and a browser.

### BACKGROUND

A browser may be divided into two parts in architecture, which are kernel and shell. The browser kernel refers to the core part of the browser, which may be divided into to two part: a layout engineer (or Rendering engine) and a JavaScript (JS) engine. The layout engineer mainly takes charge of obtaining content of webpage (including HTML, XML, images and so on), collating information (such as adding cascading style sheets (CSS) and so on), and calculating the display way of webpage, and then outputting the webpage to display or printer. Different browser kernel may lead to different grammar explanation of webpage, thusly the rendering effect may also be different. All the webpage browser, Email client side and other application which need to edit and display network content need kernel. JS engine is used to parse JavaScript language, execute JavaScript language to obtain dynamic effect of the webpage.

There are various kinds of browser kernel. The commonly-seen browser kernel is Trident kernel used by IE browser from Microsoft, Gecko kernel used by Firefox browser, Webkit kernel used by Safari browser from Apple and chrome browser from Google, and Presto kernel used by Opera browser.

When a user initiate a request for browsing webpage via the browser, the browser downloads content of target webpage, and then analyzes webpage content, executes script, calculates webpage layout, and at last outputs the content to the display to display to the user. Each browser has a kernel, the browser uses the same kernel to perform interpretive execution no matter how many webpages the user opens via one browser process.

However, the single-kernel browser has great limitation. That is because the webpage is usually made according to one network standard supported by certain kernel, other kernels may not support the network standard supported by certain kernel well (or even cannot support the network standard). For example, when the user uses Firefox browser to browse webpage, the browser kernel of Firefox may well support W3C standard, thusly using the browser may browse webpages made according to W3C standard. However, if the user wants to browse webpage of China Merchants Bank and use network bank, Firefox browser cannot satisfy the user requirement because network bank function of China Merchants Bank website needs ActiveX plug-in function, the function may only be supported by IE browser kernel. Thusly the user cannot use network bank function of China Merchants Bank when he or she uses Firefox browser.

### SUMMARY

In view of above problems, the disclosure is proposed to provide to a method for loading a webpage and a device for loading a webpage correspondingly, and a browser.

According to an aspect of the disclosure, there is provided a method for loading a webpage, comprising:

receiving a first loading request of a current webpage at a browser side using a first browser kernel; the first loading request including a URL of the current webpage;

starting obtaining and caching a first webpage resource according to the first loading request; the first webpage resource being webpage resource needed in loading the current webpage;

searching a browser kernel matching the current webpage according to the URL;

starting a second browser kernel when the browser kernel matching the current webpage is the second browser kernel; and

loading the current webpage by the second browser kernel based on the first webpage resource and the second webpage resource transmitted by the first browser kernel;

wherein the second webpage resource is remaining webpage resource needed in loading the current webpage except the first webpage resource obtained from a server side by the first browser kernel.

According to an aspect of the disclosure, there is provided a device for loading a webpage, comprising:

a first loading request receiving module, configured to receive a first loading request of a current webpage at a browser side using a first browser kernel; the first loading request including a URL of the current webpage;

a first webpage resource obtaining module, configured to start obtaining and caching a first webpage resource according to the first loading request; the first webpage resource being webpage resource needed in loading the current webpage;

a browser kernel matching module, configured to search a browser kernel matching the current webpage according to the URL;

a second browser kernel starting module, configured to start a second browser kernel when the browser kernel matching the current webpage is the second browser kernel;

a webpage loading module, configured to load the current webpage by the second browser kernel based on the first webpage resource and the second webpage resource transmitted by the first browser kernel;

wherein the second webpage resource is remaining webpage resource needed in loading the current webpage except the first webpage resource obtained from a server side by the first browser kernel.

According to still another aspect of the disclosure, there is provided a browser, comprising:

a first loading request receiving module, configured to receive a first loading request of a current webpage at browser side using a first browser kernel; the first loading request including a URL of the current webpage;

a first webpage resource obtaining module, configured to start obtaining and caching a first webpage resource according to the first loading request; the first webpage resource being webpage resource needed in loading the current webpage;

a browser kernel matching module, configured to search a browser kernel matching the current webpage according to the URL;

a second browser kernel starting module, configured to start a second browser kernel when the browser kernel matching the current webpage is the second browser kernel;

a webpage loading module, configured to load the current webpage by the second browser kernel based on the first webpage resource and the second webpage resource transmitted by the first browser kernel;

wherein the second webpage resource is remaining webpage resource needed in loading the current webpage except the first webpage resource obtained from a server side by the first browser kernel.

According to an aspect of the disclosure, there is provided a computer program, comprising computer readable codes, wherein when the computer readable codes are carried out on an electronic apparatus, the electronic apparatus executes the method for loading a webpage above.

According to an aspect of the disclosure, there is provided a computer readable medium, in which the computer program above is stored.

The beneficial effect of the disclosure lies in:

in the invention, when it is determined the current webpage is suitable to use the second browser kernel, the second browser kernel is started, the switching of browser kernel is performed, the webpage resource that is cached already to the previous browser kernel can be used repeatedly, and the webpage resource that is not cached is obtained, and then by IPC, all the obtained webpage resource is sent to the second browser kernel to render and load, which avoids repeat obtaining the webpage resource and improves webpage loading speed.

In the invention, the determination of matching the browser kernel is made before the webpage is rendered, by using the resource mapping table, the JavaScript resource corresponding to the URL of the current webpage is searched in the resource mapping table, by searching the plug-in object corresponding to the JavaScript resource in the plug-in mapping table, the matched browser kernel is determined, which improves the speed of using the browser kernel to load the webpage, and increases the efficient of loading webpage.

Described above is merely an overview of the inventive scheme. In order to more apparently understand the technical means of the disclosure to implement in accordance with the contents of specification, and to more readily understand above and other objectives, features and advantages of the disclosure, specific embodiments of the disclosure are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the disclosure. Further, throughout the drawings, same elements are indicated by same reference numbers. In the drawings:

FIG. 1 is a flow chart schematically showing the method for loading a webpage according to the first embodiment of the disclosure.

FIG. 2 is a flow chart schematically showing the method for loading a webpage according to the second embodiment of the disclosure.

FIG. 3 is a block diagram schematically showing the device for loading a webpage according to an embodiment of the disclosure.

FIG. 4 is a block diagram schematically illustrating an electronic apparatus for executing the method according the disclosure; and

FIG. 5 is a schematically diagram showing a memory unit which is used to store and carry program codes for realizing the method according to the disclosure.

### DESCRIPTION OF THE EMBODIMENTS

Exemplary embodiments of the present disclosure will be described in detail with reference to the accompanying figures hereinafter.

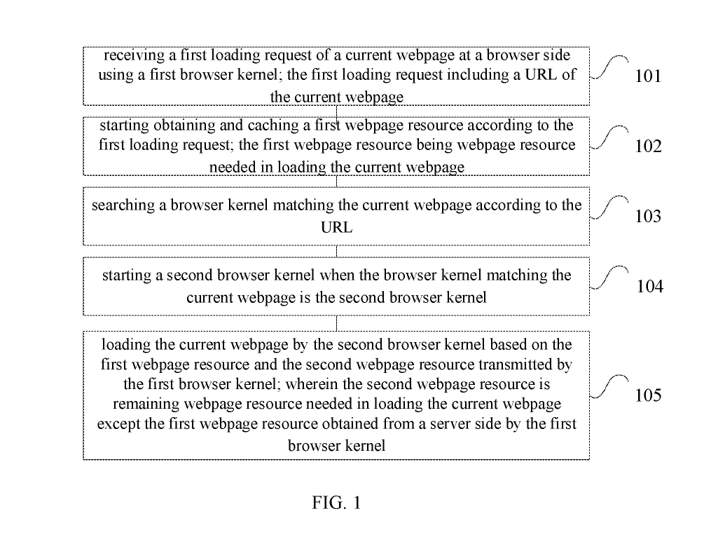

As shown in FIG. 1, it is a flow chart schematically showing the method for loading a webpage according to the first embodiment of the disclosure. The method may include the following steps:

Step 101, receiving a first loading request of a current webpage at a browser side using a first browser kernel; the first loading request including URL of the current webpage;

Step 102, starting obtaining and caching a first webpage resource according to the first loading request; the first webpage resource being webpage resource needed in loading the current webpage;

Step 103, searching a browser kernel matching the current webpage according to the URL;

Step 104, starting a second browser kernel when the browser kernel matching the current webpage is the second browser kernel;

Step 105, loading the current webpage by the second browser kernel based on the first webpage resource and the second webpage resource transmitted by the first browser kernel;

wherein the second webpage resource is remaining webpage resource needed in loading the current webpage except the first webpage resource obtained from a server side by the first browser kernel.

In the invention, the second browser kernel is started when it is determined the current webpage is suitable to be loaded by the second browser kernel, a browser kernel is switched, the cached webpage resource which is obtained when the previous browser kernel requests is re-used, and the webpage resource which is not cached yet is requested to continue obtaining, then all the obtained webpage resource is sent to the second browser kernel to perform rendering via the IPC, which avoids re-obtaining the webpage resource and increases the loading speed of the webpage.

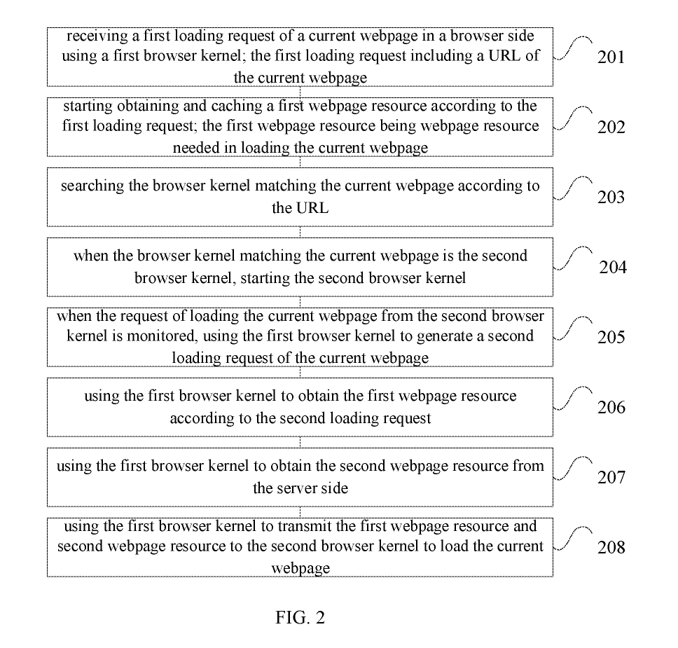

As shown in FIG. 2, it is a flow chart schematically showing the method for loading a webpage according to an embodiment of the disclosure. The method may include the following steps:

Step 201, receiving a first loading request of a current webpage at a browser side using a first browser kernel; the first loading request including URL of the current webpage;

It should be noted that, the browser may include two or more browser kernels, the first browser kernel may be a default browser kernel of the browser, the default browser kernel may be set by system or the user, which may be a high-performance browser kernel such as Webkit kernel. Obviously, it may also be Gecko kernel, Presto kernel and so on, and the embodiment of the invention is not limited thereto.

The first loading request of the current webpage may be an instruction of loading certain webpage sent by a user. For example, the user may open certain webpage by clicking certain link or open certain webpage by inputting certain URL in the address bar and so on. When the instruction is the user clicking certain link, it equals to receiving the request to load certain webpage sent by the user; similarly, when the instruction is the user inputting certain URL in the address bar and click the yes button or the enter button, it also equals to receiving the request of loading the webpage from the user.

Wherein the content of loading request may include the identification of request loading the webpage from the user and/or webpage characteristic. The webpage identification may represent a uniquely determined webpage information, such as uniform resource identifier (URI), the URI may specifically includes uniform resource locator (URL) or uniform resource name (URN) and so on.

In specific application, the first browser kernel may include a first kernel process and a second kernel process.

The kernel process may be a unit for a browser to execute programs and allocate resource.

In a preferred embodiment of the invention, step 201 may specifically include the following sub-steps:

Sub-step S11, receiving the first loading request of the current webpage at the browser side via the first kernel process.

In specific application, the first kernel process may obtain the URL of the current webpage, obviously it may be obtaining webpage identification such as the URI of the current webpage and/or URN, the embodiment of the invention is not limited thereto.

Step 202, starting obtaining and caching a first webpage resource according to the first loading request; the first webpage resource being webpage resource needed in loading the current webpage;

when the loading request of loading the webpage from the user is received, it is capable to perform normal webpage loading by the first kernel process.

In a preferred embodiment of the invention, step 202 may specifically include the following sub-step:

Sub-step S21, using the first kernel process to access the URL, and starting to obtain and cache the resource needed in loading the current webpage.

Specifically, it is capable to use the first kernel process to directly access the URL to load the current webpage. Obviously, it is also capable to use webpage identification such as the URI and/or URN to load the current webpage.

Taking the first kernel process visiting the URL to load the current webpage as an example, the loading webpage process may include the followings:

1. When the URL (assuming the user visits a HTML webpage, and the webpage is visited for the first time) entered by the user is detected, the browser sends a request to the server to load the webpage indicated by the URL, and the server feeds back corresponding HTML text;

2. The browser starts to load source code of HTML text, when detects the <head> tag includes a <link> tag inside, it is needed to quote external CSS file;

3. The browser sends a request to the server about the CSS file, the server feeds back the corresponding CSS file;

4. The browser keeps loading code in the <body> part of the HTML text, at that moment, the CSS file is received, and it is capable to start render the webpage;

5. When the browser detects an <img> tag in the HTML text, it is needed to quote an image, and the browser sends a request for loading image to the server. At that moment, the browser does not need to wait the finishing of downloading the image, instead, it continues rendering the code below;

6. The server feeds back the image file, since the image occupies certain area, paragraph arrangement in the below is affected, thusly the browser needs to re-render these part of code.

7. When the browser detects a <script> tag including a line of Javascript code, then it runs immediately;

8. The Javascript is used to execute the above statement, it orders the browser to hide a certain <div> (style.display=“none”) in the code, since there is a lack of <div> element, the browser needs to re-render this part of code.

9. When the </html> is detected, the rendering is finished;

10. When the user clicks the “change skin” button in the interface, Javascript orders the browser to change the CSS route of the <link> tag;

11. The browser uses each of the elements such as <div>, <span>, <ul>, <li>, and requests for new CSS file from the server, and re-renders the webpage.

When loading the webpage normally via the first kernel process, it is capable to determine the browser kernel which matches the current request-to-load webpage.

Step 203, searching the browser kernel matching the current webpage according to the URL;

In specific application, the method for obtaining the matching relation between the user requested webpage and the browser kernel (that is which browser kernel is suitable to load the current webpage) may include various kinds of methods.

In the first method, it is capable to obtain the adaption relation between the user requested webpage and the browser kernel according to the content obtained from the request information and the preset rule.

Detaildly, the preset rule may include specific adaption rules, general adaption rules and/or non-adaption rules. During the process of requesting to load the webpage, the adaption relation between the user requested webpage and the browser kernel may be obtained according to the specific adaption rules, general adaption rules and/or non-adaption rules. Wherein the specific adaption rules may include the adaption relation between webpages and kernels, the general adaption rules may include selecting the browser kernel whose average loading speed is the fastest for the user, or selecting the browser kernel which supports the web standard best. The non-adaption rule may include the non-adaption relation between the webpages and the kernels.

Since the browser may also send the loading request information about loading webpage to the corresponding server according to the received request information, the server may feed back response information specific to the loading request information, and the response information may carry information such as webpage content of the webpage, under this circumstance, it is also capable to re-obtain the browser kernel that is adaptive to the user requested webpage according to the obtained content from the response information specific to the loading request information from the server and preset rule; if the re-obtained adapted browser kernel is different from the adapted browser kernel which is previously obtained based on the request information, it is capable to select the re-obtained adapted browser kernel to load the user requested webpage.

In the second method, since the browser may send the loading request information about loading webpage to the server according to the received request information, the server may feed back response information specific to the loading request information, and the response information may carry information about webpage content of the webpage, therefore in the method, it is capable to obtain the adaption relation between the user requested webpage and the browser kernel directly according to the obtained content in the response information feedback specific to the loading request information feedback from the server and the preset rule.

Obviously, it is also capable obtain the adaption relation between the user requested webpage and the browser kernel both according to the obtained content from the request information and the obtained content in the response information feedback specific to the loading request information feedback from the server and the preset rule.

In addition, when using the method in each embodiment to load the webpage (which may be during the loading process and after the loading process), it is also capable to detect the condition of loading the user requested webpage; if the condition that the preset kernel needs to be switched is found, it is capable to re-obtain the browser kernel adapted to the webpage according to the preset rule, and uses the re-obtained browser kernel to load the user-requested webpage. Wherein the condition that the preset kernel needs to be switched may include: it is detected that the loading speed is low during loading, or it shows that the webpage is not displayed normally after the load is finished, and so on.

In a preferred embodiment of the invention, the step 203 may specifically include the following sub-steps:

Sub-step S31, searching JavaScript resource corresponding to the URL in a preset resource mapping table;

Sub-step S32, searching a plug-in object corresponding to the JavaScript resource in a preset plug-in mapping table;

Sub-step S33, determining the browser kernel in which the plug-in object is suitable to be operated is the browser kernel matching the current webpage.

The webpage resource needed in loading webpage may include resources such as Javascript, CSS, images and/or characteristic in HTML webpage. Webpage resources such as Javascript, CSS, images and/or characteristic may be used in webpage rendering.

Wherein the Javascript is a scripting language, the source code thereof does not need to be complied before it is sent to the client, instead, the characteristic with text format is sent to the browser and the interpreted and run by the browser. The weakness of interpretive language is lower safeness, in the JavaScript, if one interpretive language cannot be operated, the posterior language cannot be operated. In addition, since the re-interpretation is performed in each time of re-loading, after loading, some codes are delayed to be interpreted until it is run, and even be interpreted for several times, thusly the webpage loading speed is low.

Therefore, in order to increase loading speed of webpage, it is capable to invoke the browser kernel which matches the JavaScript to load the current webpage. For example, the average loading speed may be different, according to the test under the same condition, the time that the kernel of Presto executes the same Javascript is ⅓ of that the kernel of Trident and the kernel of Gecko.

In specific application, it is capable to preset resource mapping table in the browser or server. The resource mapping table may record the corresponding webpage resource when loading different webpages (which may specifically be using URL to identify different webpage, and may also be using URI and/or URN to identify different webpage), which may specifically include JavaScript.

It is capable to preset plug-in mapping table in the browser or server, the plug-in mapping table may record the started plug-in object corresponding to different JavaScript. In specific application, it is capable to use the first browser kernel to request the webpage resource and obtain the webpage resource, and return to the webpage resource data cached at the browser side, such as HTML text, images, videos and the embedded JavaScript or plug-in object, the data may be rendered and displayed during webpage loading by the browser. When interpreting the webpage resource and rendering, it is capable to search the name of the JavaScript maintained by the browser. These maintaining JavaScript may be used to match different webpages, that is different URL of webpage may correspond to different matching item of JavaScript.

It is also capable to preset browser kernel mapping table in the browser or server. The browser kernel mapping table may record browser kernel matching different plug-in object. in specific application, it is capable to load and initialize the plug-in object in the webpage resource: to the <embed> element in the webpage, the CLSID (refers to a unique ID code dispatched by the system to different applications, file types, OLE objects, special files and various kinds of system components) may be taken as a part of the webpage resource and be identified, CLSID is a unique identification of the webpage plug-in object. When matching the specific plug-in object, it is switched to corresponding browser kernel to use the browser kernel to perform a re-rendering and loading to the webpage.

For example, it is found in the preset resource mapping table that under a current webpage a JavaScript needs to be activated in loading the file under a current webpage, the JavaScript may start a loading tool, the loading tool is more suitable to be run in an browser with Trident kernel, then it is obtained that the matching relation is the current webpage is suitable to use the Trident kernel to perform loading.

It should be noted that, one or two or three of the resource mapping table, the plug-in mapping table, the browser kernel mapping table may be integrated in the same mapping table.

Correspondingly, if the resource mapping table, the plug-in mapping table, the browser kernel mapping table are pre-stored in the browser, it is capable to find in the local. If the resource mapping table, the plug-in mapping table, the browser kernel mapping table are preset in the server, it is capable to send corresponding searching request and receive information fed back from the server.

Step 204, when the browser kernel matching the current webpage is the second browser kernel, starting the second browser kernel;

Generally, the second browser kernel may be other browser kernels except the first browser kernel built-in the browser, and may be adapted to load matching current webpage in some situations, and may be Trident kernels (that is the IE kernel), including IE-com kernel (compatible to IE kernel) and/or IE-stand kernel. Obvious, it may also be Gecko kernel, Presto kernel and so on, the embodiment of the invention is not limited thereto.

Especially, when the current webpage is suitable to be loaded using the first browser kernel, it is capable to directly use the first browser kernel to load the current webpage.

In actual application, the second browser kernel may include a third kernel process. it should be illustrated is, a browser may run one or more kernel process, rather than being limited in the first kernel process, the second kernel process and the third kernel process.

In a preferred embodiment of the invention, step 204 may specifically include the following sub-steps:

Sub-step S41, discontinuing the first kernel process obtaining and caching the resource needed in loading the current webpage;

Sub-step S42, starting a third kernel process;

Sub-step S43, using the first kernel process to transmit the URL of the current webpage to the third kernel process.

When it is determined to switch the browser kernel, it is capable to stop the current browser kernel (that is the first browser kernel) from loading the current webpage. The webpage resource obtained via the first kernel process may be called first webpage resource. It should be noted that, what is the right time to obtain the matching relation between the user requested webpage and the browser kernel, and what is the right time to breaking using the first kernel process to obtain the first kernel process to obtain the cache the resource in loading the current webpage.

The first kernel process may transmit the URL of the current webpage to the third kernel process, and it also may transmit the webpage identification such as URI and/or URN in the current webpage to the third kernel process, the embodiment of the invention is not limited thereto.

Step 205, when the request of loading the current webpage from the second browser kernel is monitored, using the first browser kernel to generate a second loading request of the current webpage;

After the second browser kernel is switched to, it is capable to use the URL of current webpage via the second browser kernel to set up a new browser navigation.

In a preferred embodiment of the invention, step 205 may include sub-steps of:

Sub-step S51, invoking a network programming interface WinInet to start session management class CInternetSession;

Sub-step S52, when the request of loading webpage from the second kernel process is monitored in the session management class CInternetSession, extracting the URL in the request;

Sub-step S53, determining whether the URL in the request is the same as the URL in the current webpage; if yes, transmitting the URL in the current webpage to the second kernel process;

Sub-step S54, using the second kernel process to generate the second loading request of the current webpage specific to the URL of the current webpage.

Registering monitoring HTTP request or HTTPS request in the third kernel process, performing a CinternetSeesion object in the WinInet (which is a program logical interface for developing client application with Internet function, being capable of supporting HTTP protocol, FTP protocol and GOPHER protocol), which may be corresponding to each URL of the monitored HTTP request or HTTPS request. If it is determined that the URL is URL for current webpage, performing IPC (inter-process communication, communication between processes, which refers technique or method to two processes or threads to transmit data or signal) according to the URL of the current webpage, the URL in the third kernel process is transmitted to the third kernel process. In the third kernel process, the HTTP request may be performed based on the first browser kernel according to the URL.

Step 206, using the first browser kernel to obtain the first webpage resource according to the second loading request.

The first webpage resource is the webpage resource specific to the first loading request obtained and cached by the first browser kernel;

The first webpage resource is stored in the cache of local. To prevent repeat request of webpage resource, further increasing the speed of the webpage resource request, it is capable to directly use the first webpage resource to load the current webpage.

In a preferred embodiment of the invention, the step 206 may further include sub-steps of:

Sub-step S51, extracting the URL of the current webpage in the second loading request;

Sub-step S51, determining whether browser caching includes webpage resource corresponding to the URL; if yes, using the second kernel process to extract the webpage resource corresponding to the URL.

The first browser kernel may search in the local cache resource before requesting the webpage resource to the server corresponding to the URL, if the loaded resource corresponding to the URL exists, it is not needed to request to the server, instead, it is capable to directly use the cached resource.

Step 207, using the first browser kernel to obtain the second webpage resource from the server side;

wherein the second webpage resource is remaining webpage resource needed in loading the current webpage except the first webpage resource obtained from a server side by the first browser kernel.

When discontinuing the first kernel process obtaining and caching the resource needed in loading the current webpage, the first webpage resource obtained by the first kernel process may not be all the webpage resource needed in loading the current webpage, to load the remaining webpage resource needed in the current webpage, it is capable to send request to the server.

In a preferred embodiment of the invention, the step 207 may specifically include the following sub-steps:

Sub-step S71, setting a user agent UserAgent to an identification for indicating the second browser kernel in the second kernel process;

Sub-step S72, requesting to the server side to load the current webpage via accessing the URL of the current webpage; the request including an identification of the second webpage resource; the server being configured to extract the second webpage resource.

Sub-step S73, receiving the second webpage resource feedback from the server side.

To the webpage resource corresponding to the URL that is not downloaded (that is the second webpage resource), it is capable to generate a request based on the first browser kernel to request the webpage resource that is not yet downloaded. In specific application, to the downloaded webpage resource (that is the first webpage resource) and the webpage resource that is not yet downloaded, it is capable to use different marks to separate the two kinds of webpage resources. However, the parameter of the user agent UserAgent in the request based on the request of the first browser kernel architecture needs to be set as indicating the identification of the second browser kernel.

Obviously, the obtained second webpage resource may also be stored in the local cache.

Step 208, using the first browser kernel to transmit the first webpage resource and second webpage resource to the second browser kernel to load the current webpage.

The first webpage resource and the second webpage resource may be loading all the resources of the current webpage, when the second browser kernel obtains the first webpage resource and the second webpage resource, it is capable to use the second browser kernel to render the current webpage.

In a preferred embodiment of the invention, step 208 may include the following sub-steps:

Sub-step S81, using Inter-process communication (IPC) in the second kernel process to transmit the first webpage resource and the second webpage resource to the third kernel process;

Sub-step S82, using the third kernel process and rendering the current webpage by first webpage resource and the second webpage resource.

In specific application, by IPC communication, the cached webpage resource (first webpage resource and second webpage resource) are transmitted to the third kernel process, the read function of the second browser kernel may be stored in the webpage resource already and process the sequence rendering and displaying.

In the invention, when it is determined the current webpage is suitable to use the second browser kernel, the second browser kernel is started, the switching of browser kernel is performed, the webpage resource that is cached already to the previous browser kernel can be used repeatedly, and the webpage resource that is not cached is obtained, and then by IPC, all the obtained webpage resource is sent to the second browser kernel to render and load, which avoids repeat obtaining the webpage resource and improves webpage loading speed.

In the invention, the determination of matching the browser kernel is made before the webpage is rendered, by using the resource mapping table, the JavaScript resource corresponding to the URL of the current webpage is searched in the resource mapping table, by searching the plug-in object corresponding to the JavaScript resource in the plug-in mapping table, the matched browser kernel is determined, which improves the speed of using the browser kernel to load the webpage, and increases the efficient of loading webpage.

Referred to FIG. 3, it is a structural block diagram showing the device for loading a webpage according to an embodiment of the invention, which may specifically include the following modules:

a first loading request receiving module 301, configured to receive a first loading request of a current webpage at a browser side using a first browser kernel; the first loading request including URL of the current webpage;

a first webpage resource obtaining module 302, configured to start obtaining and caching a first webpage resource according to the first loading request; the first webpage resource being webpage resource needed in loading the current webpage;

a browser kernel matching module 303, configured to search a browser kernel matching the current webpage according to the URL;

a second browser kernel starting module 304, configured to start a second browser kernel when the browser kernel matching the current webpage is the second browser kernel;

a webpage loading module 305, configured to load the current webpage by the second webpage resource based on first webpage resource and second browser kernel transmitted by the first browser kernel;

wherein the second webpage resource is remaining webpage resource needed in loading the current webpage except the first webpage resource obtained from a server side by the first browser kernel.

In a preferred embodiment of the invention, the webpage loading module is further configured to:

when the request of loading the current webpage from the second browser kernel is monitored, use the first browser kernel to generate a second loading request of the current webpage;

use the first browser kernel to obtain the first webpage resource according to the second loading request;

use the first browser kernel to obtain the second webpage resource from the server side;

use the first browser kernel to transmit the first webpage resource and the second webpage resource to the second browser kernel to load the current webpage.

In a preferred embodiment of the invention, the first browser kernel comprises a first kernel process and a second kernel process, the second browser kernel comprises a third kernel process.

In a preferred embodiment of the invention, the first loading request receiving module is further configured to:

receiving the first loading request of the current webpage at the browser side via the first kernel process.

In a preferred embodiment of the invention, the first webpage resource obtaining module is further configured to:

use the first kernel process to access the URL, and starting to obtain and cache the resource needed in loading the current webpage.

In a preferred embodiment of the invention, the browser kernel matching module is further configured to:

search JavaScript resource corresponding to the URL in a preset resource mapping table;

search a plug-in object corresponding to the JavaScript resource in a preset plug-in mapping table;

determine the browser kernel in which the plug-in object is suitable to be operated is the browser kernel matching the current webpage.

In a preferred embodiment of the invention, the second browser kernel starting module is further configured to:

discontinue the first kernel process obtaining and caching the resource needed in loading the current webpage;

start a third kernel process;

use the first kernel process to transmit the URL of the current webpage to the third kernel process.

In a preferred embodiment of the invention, the webpage loading module is further configured to:

invoke a network programming interface WinInet to start session management class CInternetSession;

when the request of loading webpage from the second kernel process is monitored in the session management class CInternetSession, extracting the URL in the request;

determine whether the URL in the request is the same as the URL in the current webpage; if yes, transmitting the URL in the current webpage to the second kernel process;

use the second kernel process to generate the second loading request of the current webpage specific to the URL of the current webpage.

In a preferred embodiment of the invention, the webpage loading module is further configured to:

extract the URL of the current webpage in the second loading request;

determine whether browser caching includes webpage resource corresponding to the URL;

if yes, using the second kernel process to extract the webpage resource corresponding to the URL.

In a preferred embodiment of the invention, the webpage loading module is further configured to:

set a user agent UserAgent to an identification for indicating the second browser kernel in the second kernel process;

request to the server side to load the current webpage via accessing the URL of the current webpage; the request including an identification of the second webpage resource; the server being configured to extract the second webpage resource;

receive the second webpage resource fedback from the server side.

In a preferred embodiment of the invention, the webpage loading module is further configured to:

use Inter-process communication (IPC) in the second kernel process to transmit the first webpage resource and the second webpage resource to the third kernel process;

use the third kernel process and rendering the current webpage by first webpage resource and the second webpage resource.

To the device embodiment, since it is basically similar as the method embodiment, the description is relative simple, the related part may be referred to the method embodiment part.

The invention further includes a browser, which may include the following modules:

a first loading request receiving module 301, configured to receive a first loading request of a current webpage at a browser side using a first browser kernel; the first loading request including URL of the current webpage;

a first webpage resource obtaining module 302, configured to start obtaining and caching a first webpage resource according to the first loading request; the first webpage resource being webpage resource needed in loading the current webpage;

a browser kernel matching module 303, configured to search a browser kernel matching the current webpage according to the URL;

a second browser kernel starting module 304, configured to start a second browser kernel when the browser kernel matching the current webpage is the second browser kernel;

a webpage loading module 305, configured to load the current webpage by the second browser kernel based on the first webpage resource and the second webpage resource transmitted by the first browser kernel;

wherein the second webpage resource is remaining webpage resource needed in loading the current webpage except the first webpage resource obtained from a server side by the first browser kernel.

In a preferred embodiment of the invention, the webpage loading module is further configured to:

when the request of loading the current webpage from the second browser kernel is monitored, use the first browser kernel to generate a second loading request of the current webpage;

use the first browser kernel to obtain the first webpage resource according to the second loading request;

use the first browser kernel to obtain the second webpage resource from the server side;

use the first browser kernel to transmit the first webpage resource and the second webpage resource to the second browser kernel to load the current webpage.

In a preferred embodiment of the invention, the first browser kernel comprises a first kernel process and a second kernel process, the second browser kernel comprises a third kernel process.

In a preferred embodiment of the invention, the first loading request receiving module is further configured to:

receiving the first loading request of the current webpage at the browser side via the first kernel process.

In a preferred embodiment of the invention, the first webpage resource obtaining module is further configured to:

use the first kernel process to access the URL, and starting to obtain and cache the resource needed in loading the current webpage.

In a preferred embodiment of the invention, the browser kernel matching module is further configured to:

search JavaScript resource corresponding to the URL in a preset resource mapping table;

search a plug-in object corresponding to the JavaScript resource in a preset plug-in mapping table;

determine the browser kernel in which the plug-in object is suitable to be operated is the browser kernel matching the current webpage.

In a preferred embodiment of the invention, the second browser kernel starting module is further configured to:

discontinue the first kernel process obtaining and caching the resource needed in loading the current webpage;

start a third kernel process;

use the first kernel process to transmit the URL of the current webpage to the third kernel process.

In a preferred embodiment of the invention, the webpage loading module is further configured to:

invoke a network programming interface WinInet to start session management class CInternetSession;

when the request of loading webpage from the second kernel process is monitored in the session management class CInternetSession, extracting the URL in the request;

determine whether the URL in the request is the same as the URL in the current webpage; if yes, transmitting the URL in the current webpage to the second kernel process;

use the second kernel process to generate the second loading request of the current webpage specific to the URL of the current webpage.

In a preferred embodiment of the invention, the webpage loading module is further configured to:

extract the URL of the current webpage in the second loading request;

determine whether browser caching includes webpage resource corresponding to the URL;

if yes, using the second kernel process to extract the webpage resource corresponding to the URL.

In a preferred embodiment of the invention, the webpage loading module is further configured to:

set a user agent UserAgent to an identification for indicating the second browser kernel in the second kernel process;

request to the server side to load the current webpage via accessing the URL of the current webpage; the request including an identification of the second webpage resource; the server being configured to extract the second webpage resource;

receive the second webpage resource fedback from the server side.

In a preferred embodiment of the invention, the webpage loading module is further configured to:

use Inter-process communication (IPC) in the second kernel process to transmit the first webpage resource and the second webpage resource to the third kernel process;

use the third kernel process and rendering the current webpage by first webpage resource and the second webpage resource.

Each of components according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the members of the device for webpage zooming on an electronic apparatus according to the embodiments of the disclosure. The disclosure may further be implemented as equipment or device programs (for example, computer programs and computer program products) for executing some or all of the methods as described herein. The programs for implementing the disclosure may be stored in the computer readable medium, or have a form of one or more signal. Such a signal may be downloaded from the internet websites, or be provided in carrier, or be provided in other manners.

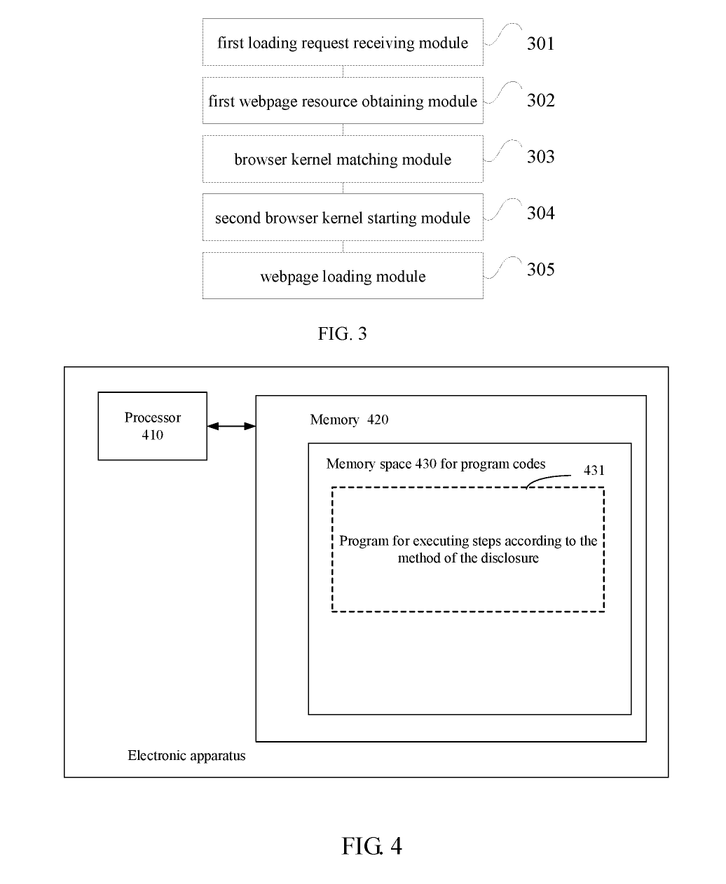

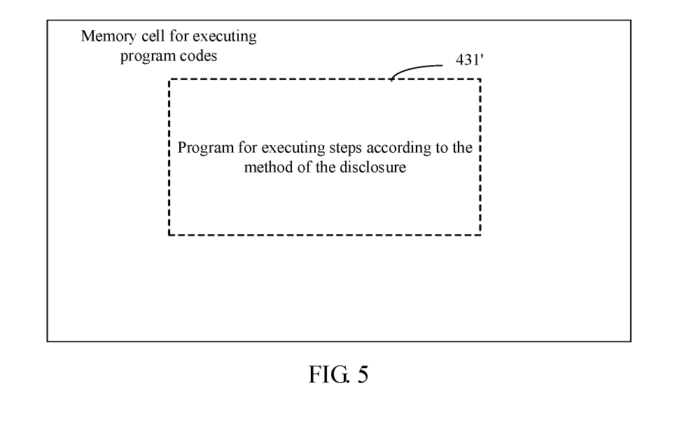

For example, FIG. 4 is a block diagram schematically illustrating an electronic apparatus for realizing webpage loading according the disclosure, such as an application server. Traditionally, the server includes a processor 410 and a computer program product or a computer readable medium in form of a memory 420. The memory 420 may be electronic memories such as flash memory, EEPROM (Electrically Erasable Programmable Read-Only Memory), EPROM, hard disk or ROM. The memory 420 has a memory space 430 for executing program codes 431 of respective steps in the above methods. For example, the memory space 430 for program codes may include respective program codes 431 for implementing the respective steps in the above mentioned method. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the server as shown in FIG. 4. The program codes may be compressed in an appropriate form. Usually, the memory cell includes computer readable codes 431′ which can be read by processors such as 410. When these codes are operated on the server, the server may execute respective step as described in the above method.

The “an embodiment”, “embodiments” or “one or more embodiments” mentioned in the disclosure means that the specific features, structures or performances described in combination with the embodiment(s) would be included in at least one embodiment. Moreover, it should be noted that, for example, the wording “in an embodiment” herein may necessarily not refer to the same embodiment.

Many details are discussed in the specification provided herein. However, it should be understood that the embodiments of the disclosure can be implemented without these specific details. In some examples, the well-known method, structure and technology are not illustrated in detail, so as to avoid an unclear understanding of the specification.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than for explaining or defining the subject matter of the disclosure. Therefore, it is obvious for an ordinary skilled person in the art that modifications and variations could be made without departing from the scope and spirit of the claims as appended. For the scope of the disclosure, the inventive disclosure is illustrative rather than restrictive, and the scope of the disclosure is defined by the appended claims.

1. A method for loading a webpage, comprising:
receiving a first loading request of a current webpage at a browser side using a first browser kernel; the first loading request including a URL of the current webpage;
starting obtaining and caching a first webpage resource according to the first loading request; the first webpage resource being webpage resource needed in loading the current webpage;
searching a browser kernel matching the current webpage according to the URL;
starting a second browser kernel when the browser kernel matching the current webpage is the second browser kernel; and
loading the current webpage by the second browser kernel based on the first webpage resource and the second webpage resource transmitted by the first browser kernel;
wherein the second webpage resource is remaining webpage resource needed in loading the current webpage except the first webpage resource obtained from a server side by the first browser kernel.

2. The method according to claim 1, wherein the step of loading the current webpage by the second browser kernel based on the first webpage resource and the second webpage resource transmitted by the first browser kernel comprises:
when the request of loading the current webpage from the second browser kernel is monitored, using the first browser kernel to generate a second loading request of the current webpage;
using the first browser kernel to obtain the first webpage resource according to the second loading request;
using the first browser kernel to obtain the second webpage resource from the server side;
using the first browser kernel to transmit the first webpage resource and the second webpage resource to the second browser kernel to load the current webpage.

3. The method according to claim 1, wherein the first browser kernel comprises a first kernel process and a second kernel process, the second browser kernel comprises a third kernel process.

4.-5. (canceled)

6. The method according to claim 1, wherein the step of searching the browser kernel matching the current webpage according to the URL comprises:
searching JavaScript resource corresponding to the URL in a preset resource mapping table;
searching a plug-in object corresponding to the JavaScript resource in a preset plug-in mapping table;
determining the browser kernel in which the plug-in object is suitable to be operated is the browser kernel matching the current webpage.

7. The method according to claim 1, wherein the step of starting the second browser kernel comprises:
discontinuing the first kernel process obtaining and caching the resource needed in loading the current webpage;
starting a third kernel process;
using the first kernel process to transmit the URL of the current webpage to the third kernel process.

8. The method according to claim 7, wherein when the request of loading the current webpage from the second browser kernel is monitored, using the first browser kernel to generate a second loading request of the current webpage comprises:
invoking a network programming interface WinInet to start session management class CInternetSession;
when the request of loading the webpage from the second kernel process is monitored in the session management class CInternetSession, extracting the URL in the request;
determining whether the URL in the request is the same as the URL in the current webpage; if yes, transmitting the URL in the current webpage to the second kernel process;
using the second kernel process to generate the second loading request of the current webpage specific to the URL of the current webpage.

9. The method according to claim 8, wherein the step of using the first browser kernel to obtain the first webpage resource according to the second loading request comprises:
extracting the URL of the current webpage in the second loading request;
determining whether browser caching includes the webpage resource corresponding to the URL; if yes, using the second kernel process to extract the webpage resource corresponding to the URL.

10. The method according to claim 8, wherein the step of obtaining the second webpage resource from the server side using the first browser kernel comprises:
setting a user agent UserAgent to an identification for indicating the second browser kernel in the second kernel process;
requesting to the server side to load the current webpage via accessing the URL of the current webpage; the request including an identification of the second webpage resource; the server being configured to extract the second webpage resource;
receiving the second webpage resource fedback from the server side.

11. The method according to claim 3, wherein the step of using the first browser kernel to transmit the first webpage resource and the second webpage resource to the second browser kernel to load the current webpage comprises:
using Inter-process communication (IPC) in the second kernel process to transmit the first webpage resource and the second webpage resource to the third kernel process;
using the third kernel process and rendering the current webpage by the first webpage resource and the second webpage resource.

12. An electronic apparatus for loading a webpage, comprising:
a memory having instructions stored thereon;
a processor configured to execute the instructions to perform operations for loading a webpage, comprising:
receiving a first loading request of a current webpage at a browser side using a first browser kernel; the first loading request including a URL of the current webpage;
starting obtaining and caching a first webpage resource according to the first loading request; the first webpage resource being webpage resource needed in loading the current webpage;
searching a browser kernel matching the current webpage according to the URL;
starting a second browser kernel when the browser kernel matching the current webpage is the second browser kernel;
loading the current webpage by the second browser kernel based on the first webpage resource and the second webpage resource transmitted by the first browser kernel;
wherein the second webpage resource is remaining webpage resource needed in loading the current webpage except the first webpage resource obtained from a server side by the first browser kernel.

13. The electronic apparatus according to claim 12, wherein loading the current webpage by the second browser kernel based on the first webpage resource and the second webpage resource transmitted by the first browser kernel comprises:
when the request of loading the current webpage from the second browser kernel is monitored, using the first browser kernel to generate a second loading request of the current webpage;
using the first browser kernel to obtain the first webpage resource according to the second loading request;
using the first browser kernel to obtain the second webpage resource from the server side;
using the first browser kernel to transmit the first webpage resource and the second webpage resource to the second browser kernel to load the current webpage.

14. The electronic apparatus according to claim 12, wherein the first browser kernel comprises a first kernel process and a second kernel process, the second browser kernel comprises a third kernel process.

15. (canceled)

16. The electronic apparatus according to claim 14, wherein the starting obtaining and caching a first webpage resource according to the first loading request comprises:
using the first kernel process to access the URL, and starting to obtain and cache the resource needed in loading the current webpage.

17. The electronic apparatus according to claim 12, wherein the searching the browser kernel matching the current webpage according to the URL comprises:
searching JavaScript resource corresponding to the URL in a preset resource mapping table;
searching a plug-in object corresponding to the JavaScript resource in a preset plug-in mapping table;
determining the browser kernel in which the plug-in object is suitable to be operated is the browser kernel matching the current webpage.

18. The electronic apparatus according to claim 15, wherein the starting the second browser kernel comprises:
discontinuing the first kernel process obtaining and caching the resource needed in loading the current webpage;
starting a third kernel process;
using the first kernel process to transmit the URL of the current webpage to the third kernel process.

19. The electronic apparatus according to claim 18, wherein when the request of loading the current webpage from the second browser kernel is monitored, using the first browser kernel to generate a second loading request of the current webpage comprises:
invoking a network programming interface WinInet to start session management class CInternetSession;
when the request of loading the webpage from the second kernel process is monitored in the session management class CInternetSession, extracting the URL in the request;
determining whether the URL in the request is the same as the URL in the current webpage; if yes, transmitting the URL in the current webpage to the second kernel process;
using the second kernel process to generate the second loading request of the current webpage specific to the URL of the current webpage.

20. The electronic apparatus according to claim 19, wherein using the first browser kernel to obtain the first webpage resource according to the second loading request comprises:
extracting the URL of the current webpage in the second loading request;
determining whether browser caching includes the webpage resource corresponding to the URL; if yes, using the second kernel process to extract the webpage resource corresponding to the URL.

21. The electronic apparatus according to claim 20, wherein obtaining the second webpage resource from the server side using the first browser kernel comprises:
setting a user agent UserAgent to an identification for indicating the second browser kernel in the second kernel process;
requesting to the server side to load the current webpage via accessing the URL of the current webpage; the request including an identification of the second webpage resource; the server being configured to extract the second webpage resource;
receiving the second webpage resource fedback from the server side.

22. The electronic apparatus according to claim 14, wherein using the first browser kernel to transmit the first webpage resource and the second webpage resource to the second browser kernel to load the current webpage comprises:
using Inter-process communication (IPC) in the second kernel process to transmit the first webpage resource and the second webpage resource to the third kernel process;
using the third kernel process and rendering the current webpage by the first webpage resource and the second webpage resource.

23.-25. (canceled)

25. A non-transitory computer readable medium,
having computer programs stored thereon that, when executed by one or more processors of an electronic apparatus, cause the electronic apparatus to perform;
receiving a first loading request of a current webpage at a browser side using a first browser kernel; the first loading request including a URL of the current webpage;
starting obtaining and caching a first webpage resource according to the first loading request; the first webpage resource being webpage resource needed in loading the current webpage;
searching a browser kernel matching the current webpage according to the URL;
starting a second browser kernel when the browser kernel matching the current webpage is the second browser kernel; and
loading the current webpage by the second browser kernel based on the first webpage resource and the second webpage resource transmitted by the first browser kernel;
wherein the second webpage resource is remaining webpage resource needed in loading the current webpage except the first webpage resource obtained from a server side by the first browser kernel.
